(19) United States
(12) Patent Application Publication
(10) Pub. No.: US 2007/0274403 A1
(43) Pub. Date: Nov. 29, 2007

(54) Method for Constituting Layered Cell in Ofdma System

(76) Inventors: Sung-Cheol Chang, Daejeon-city (KR); Jae-Sun Cha, Daejeon-city (KR); Kyung-Soo Kim, Daejeon-city (KR); Jee Hwan Ahn, Daejeon-city (KR)

Correspondence Address: THE FARRELL LAW FIRM, P.C., 333 EARLE OVINGTON BOULEVARD, SUITE 701, UNIONDALE, NY, 11553, US

(21) Appl. No.: 10/584,437

(22) PCT Filed: Dec. 22, 2004
(86) PCT No.: PCT/KR04/03408

§ 371 Date: Jun. 7, 2007

(30) Foreign Application Priority Data
Dec. 23, 2003 (KR) 10-2003-0095017
May 19, 2004 (KR) 10-2004-0035542

(51) Int. Cl. H04L 27/28

(52) U.S. Cl. 375/260

(57) ABSTRACT

Disclosed is a method for constituting a layered cell, which is for constituting a cell in an OFDMA (Orthogonal Frequency Division Multiple Access) mobile communication system. The method includes: (a) dividing L carriers having orthogonality into M sub-channels; (b) dividing the carriers into N groups each having the M sub-channels; (c) grouping the N groups by an arbitrary integer into K classes; and (d) constituting a plurality of layered cells corresponding to the K classes. According to the present invention, the conception of the independent classes is introduced for a plurality of carriers to facilitate the use of the carriers to a system requiring an independent wireless area, allowing design of sectors and cells at a single frequency.

### TECHNICAL FIELD

The present invention relates to a method for constituting a layered cell in an OFDMA (Orthogonal Frequency Division Multiple Access) system. More specifically, the present invention relates to a method for constituting a layered cell of an OFDMA system for a plurality of carriers in an OFDMA mobile communication system.

### BACKGROUND ART

Recently, the mobile communication system developed up to IMT-2000 (International Mobile Telecommunication-2000) is based on the CDMA (Code Division Multiple Access) technology, and demands a wider bandwidth than the existing second-generation mobile communication system. With the introduction of packet technology, the tendency of development of the mobile communication system is towards a design of the packet method, such as asynchronous HSDPA (High-Speed Downlink Packet Access) system and CDMA-2000 1×EV-DV (1× Evolution Data and Voice) systems.

These systems have a limitation on the transmission of wideband data requested by a user because of the spreading technique of the CDMA. The OFDMA technology stands out in bold relief as a substitute measure to overcome this problem.

The OFDMA technology is a method of operating multiple frequencies with orthogonality. In the OFDMA technology, the modulation and demodulation techniques are implemented using IFFT (Inverse Fast Fourier Transform) and FFT (Fast Fourier Transform) technologies, and are used for transmission of wideband data.

For example, IEEE 802.11 WLAN (Wide Local Area Network) and IEEE 802.16 WMAN (Wide Metropolitan Area Network) employ the OFDMA method for high-speed packet data transmission, and they also include the packet method. Here, the WLAN uses the band contention method to readily design a wireless interval for small cells. The WMAN increases the cell radius to support a great number of users on the wireless interval, and uses the OFDMA method suitable for wideband to provide a maximum user band of up to 50 Mbps.

Korean Patent Application NM. 1999-62375 (filed on Dec. 27, 1999) discloses “An apparatus and method for constituting a MAC (Medium Access Control) frame suitable for OFDMA wireless LAN”. This cited invention provides an apparatus and method for constituting a MAC frame for efficient information communication between a mobile station and a base station in a wireless LAN system for transmission of IP (Internet Protocol) packets or ATM (Asynchronous Transfer Mode) cells.

More specifically, the invention of Korean Patent Application No. 1999-62375 enhances the uplink contention transmission interval at the start of the uplink transmission link to allow rapid contention signal processing, and secures an allowance time for processing the result of the uplink contention interval in hardware implementation in the method for constituting a MAC frame of a wireless LAN system for transmission of IP packets or ATM cells by the OFDMA modulation method.

VTC, 2000. IEEE VTS-Fall VTC 2000. 52nd Volume No. 6, page 3040 (published on Sep. 24, 2000) introduced a paper under the title of “Transmission Delay Control for Single Frequency OFDM Multi-Base-Station in a Cell Using Position Information”.

This cited paper introduces the sub-cell conception to the existing cell, and proposes a transmission delay control system using position information based on GPS. The control system is advantageous in propagation loss and shadow effect, and is particularly superior in high-speed data transmission.

On the other hand, PCT Application No. PCT/US02/19273 (filed on Jun. 18, 2002) discloses an invention under the title of “Method of Tone Allocation for Tone Hopping Sequences”. The cited invention relates to a method and apparatus for allocation of carriers for the purpose of communication for OFDM systems that allocates carriers in sequence in carrier hopping, and constitutes a cell with the carriers and a traffic channel in a similar manner, allowing communication by an authorized mobile station only rather than mobile stations not in synchronization in the carrier hopping sequence.

However, a problem with the prior art is encountered in regard to inefficiency in the use of wireless resources for allocation of a plurality of cells and resource management.

### DISCLOSURE OF INVENTION

Technical Problem

It is an advantage of the present invention to provide a method for constituting layered cells in an OFDMA system that divides a carrier to implement sectors and cells by layers in designing a cell.

It is another advantage of the present invention to provide a method for constituting layered cells in an OFDMA system that allocates cells using carriers divided in the class conception to efficiently use wireless resources by resource management.

Technical Solution

In one aspect of the present invention, there is provided a method for constituting a layered cell in an OFDMA that includes: (a) dividing L carriers having orthogonality into M sub-channels; (b) dividing the carriers into N groups each having the M sub-channels; (c) grouping the N groups by an arbitrary integer into K classes; and (d) constituting a plurality of layered cells corresponding to the K classes.

In the step (c), the respective K classes include the sane or a different number of groups.

The step (c) includes: sequentially allocating the groups to each of the K classes, and allocating the (nK+k)-th group to the k-th class, when the respective K classes include the same number of groups.

The step (c) includes: randomly allocating the respective N groups to each of the classes, when the respective K classes include a different number of groups.

The plural layered cells of the step (d) includes sector layers comprising a plurality of sectors classified by wireless areas, and a cell layer comprising a single cell corresponding to an overall cell area.

The step (d) includes: (d-1) allocating a capacity by sectors classified by wireless areas to map the classes to capacity; (d-2) generating the classes by as many as the number of sectors; and (d-3) allocating each class by sectors to constitute the sectors.

The step (d) includes: (d-1) grouping the classes in a number of the sectors plus one; (d-2) allocating each class to a sector area; and (d-3) allocating the remaining one class to a cell including the cell area.

The step (d) includes: (d-1) grouping the N groups into two classes; (d-2) allocating one class to the sector layers to allocate wireless resources for the classes equal in number to the sectors; and (d-3) allocating the other class to the cell layer.

The step (d-2) includes using a channel encoding technique and a forward error compensation method for data transmission, when a collision occurs at a boundary of the sectors.

The step (d-3) includes allocating wireless resources equally throughout the area of the cell layer to constitute a layered cell structure.

The sector layers allow a use of wireless resources for a user having a low movement speed, the cell layer allowing a use of wireless resources for a user having a high movement speed.

The sector layers allow a use of wireless resources for a service having a low priority, the cell layer allowing a use of wireless resources for a service having a high priority.

The sector layers allocate resources of the cell layer to a user requiring a high data rate in the vicinity of a sector boundary to allow a selection of AMC (Adaptive Modulation Coding) for high-speed data transmission.

In another aspect of the present invention, there is provided a method for constituting a layered cell in an OFDMA mobile communication system that includes: (a) dividing L carriers having orthogonality into M sub-channels; (b) dividing the carriers into N groups each having the M sub-channels; (c) grouping the M sub-channels by an arbitrary integer into K classes; and (d) constituting a plurality of layered cells corresponding to the K classes.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an illustration showing an allocation of carriers in the sub-channel and group conceptions according to an embodiment of the present invention;

FIG. 2 is an illustration showing a class conception for group division according to an embodiment of the present invention;

FIG. 3 is an illustration showing sequential group allocation according to an embodiment of the present invention;

FIG. 4 is an illustration showing a sector construction using independent classes according to an embodiment of the present invention;

FIG. 5 is an illustration showing sector layers and a single cell layer of independent classes in a layered cell structure according to an embodiment of the present invention;

FIG. 6 is an illustration showing sector layers and a single cell layer of a single class in a layered cell structure according to an embodiment of the present invention; and

FIG. 7 is an illustration showing a class conception for sub-channel allocation according to an embodiment of the present invention.

### BEST MODE FOR CARRYING OUT THE INVENTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

Hereinafter, a method for constituting a layered cell in an OFDMA system according to an embodiment of the present invention will be described in detail with reference to the accompanying drawings.

The embodiment of the present invention provides a method of introducing a conception of “class” as an upper conception for the basic conception of sub-channels and groups for a plurality of carriers, applying the class to the cell design to constitute a layered cell, and efficiently using wireless resources in the layered cell.

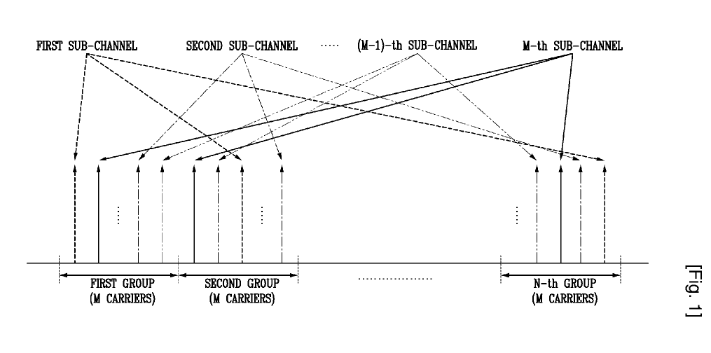

FIG. 1 is an illustration showing an allocation of carriers in the sub-channel and group conceptions according to an embodiment of the present invention, where N×M carriers used for OFDMA are allocated by sub-channels and groups.

More specifically, referring to FIG. 1, carriers are divided into N M-carrier groups in the IEEE 802.16 OFDMA system, where M is equal to the number of sub-channels. Namely, each of the N carrier groups comprises M carriers, which are allocated in sequence. Here, N and M are independently integers.

The basic conception is that the carriers belonging to a sub-channel are allocated to every group to allocate each data. M sub-channels are allocated to each user by sub-channels in the units of slots. M users can use each sub-channel, or one user can use M sub-channels. For the sub-channels allocated to one user, the carriers are divided into N groups, so the effect on the user data allocation is distributed over the N groups.

On the other hand, a single-frequency WMAN system uses a method of dividing sub-channels into groups of as many as the number of sectors. The sub-channels allocated by sectors are arranged without overlap to constitute sectors between which pilots are allocated. The mobile station receives pilot carriers having a defined position and a defined profile, and uses them as signal intensity in the sector. This is a method used in the IEEE 802.16 standard that divides a sub-channel resource in a single frequency by sectors to disadvantageously reduce the wireless capacity used for one sector from the total single wireless capacity to the proportion of the sub-channels allocated to one sector. The carriers used for the sector are distributed over the whole frequency. Here, the carriers allocated to each group can be distributed with regularity.

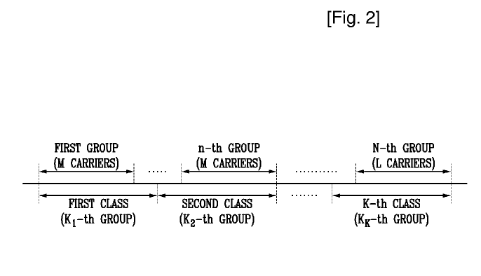

FIG. 2 is an illustration showing a class conception for group division according to an embodiment of the present invention, where the class conception is introduced in addition to the group and sub-channel conception of FIG. 1.

Referring to FIG. 2, in the environment that all the carriers are divided into N groups, the groups are divided into K classes, each of which comprises a plurality of groups. Here, the respective K classes may have the sane or a different number of groups. The classes are allocated to an independent wireless region represented by a sector and used for sector and cell allocation.

When the class conception is introduced to the sector applied in the WMAN system, N groups are changed to M sub-channels, and the sub-channels are allocated to K classes. For example, 3 sectors are divided at a capacity proportion such that M sub-channels are allocated to 3 classes, each of which is allocated to the sectors.

Referring to FIGS. 1 and 2, the method for constituting a layered cell in an OFDMA system according to an embodiment of the present invention includes dividing L carriers having orthogonality into M sub-channels, and then into N groups each having the M sub-channels.

Subsequently, the respective N groups or the M sub-channels are allocated to K classes, and the L carriers are divided according to the K classes to constitute a plurality of layered cells corresponding to the K classes. In case of constituting a plurality of layered cells corresponding to the K classes, capacity is allocated by sectors divided by the wireless areas to map the classes to capacity, and the number of classes is made equal to that of the sectors, each class being allocated to the sectors to constitute the sectors.

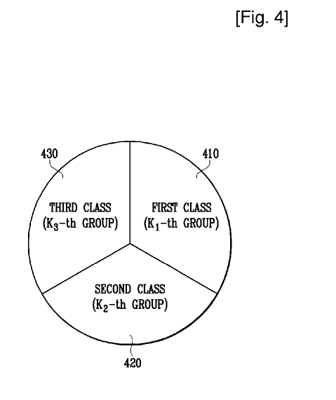

Here, the plural layered cells may include a sector layer comprising sectors divided by wireless areas, and a cell layer comprising a single cell corresponding to the overall cell area, which will be described later with reference to FIGS. 4, 5, and 6.

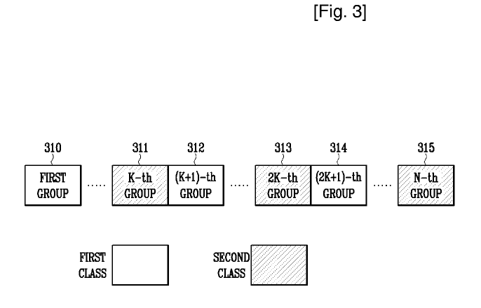

FIG. 3 is an illustration showing a sequential group allocation according to an embodiment of the present invention, where N groups 310, . . . , 315 to be allocated to K classes are divided sequentially so as to achieve a maximum distribution.

Referring to FIG. 3, when N is an integral multiple of K, the individual classes are sequentially distributed to K classes. The (nK+k)-th group is allocated to the k-th class, where n is an integer greater than 0. For example, the first group 310, the (K+1)-th group 312, and the (2K+1)-th group 314 belong to the first class, and the K-th group 311, the 2K-th group 312 and the N-th group 314 belong to the second class. Namely, when N is an integral multiple of K, the N groups are sequentially grouped into K groups, and sane of the groups are selected and allocated to a class to constitute the class. This is a group allocation method introduced in the method of constituting the class, as illustrated in FIG. 3.

Alternatively, the N groups are arranged in integer multiples of the number of the classes, K, and are randomly allocated to the respective classes.

FIG. 4 is an illustration showing a sector construction using independent classes according to an embodiment of the present invention, where the classes shown in FIG. 3 are applied to the sectors.

First, the groups are divided into 3 classes, and the respective classes 410, 420, and 430 are applied to a 3-sector cell. The first class 410 comprises K₁ groups, the second class 420 comprises K₂ groups, and the third class 430 comprises K₃ groups. Here, the carriers are allocated to independent classes, causing no interference, but the number of carriers allocated by the classes decreases to reduce the amount of data used by the user.

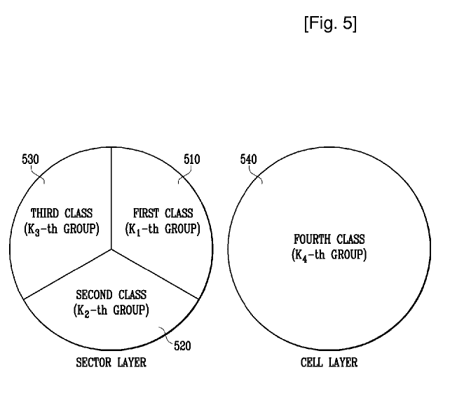

FIG. 5 is an illustration showing sector layers and a single cell layer of independent classes in a layered cell structure according to an embodiment of the present invention, where a single frequency is divided into sector layers and a cell layer in a layered cell structure.

First, the sector layers 510, 520, and 530 constitute a cell using the sectors comprising the independent classes as shown in FIG. 4. The cell layer 540 constitutes a cell with a single wireless area throughout the cell area. This layered structure comprises 2 types of layers, and the carriers comprise 4 independent classes. The first, second, and third classes 510, 520, and 530 are applied to the sector layers by sectors, and the fourth class 540 is applied to the cell layer.

The resources allocated to the sector layers and the cell layer are used differently according to resource management method. For example, the users having a low movement speed are allocated to the sector layers 510, 520, and 530 which are relatively small in area, whereas the users having a high movement speed are allocated to the cell layer 540 which is relatively large in area, thereby reducing the incidence of handover.

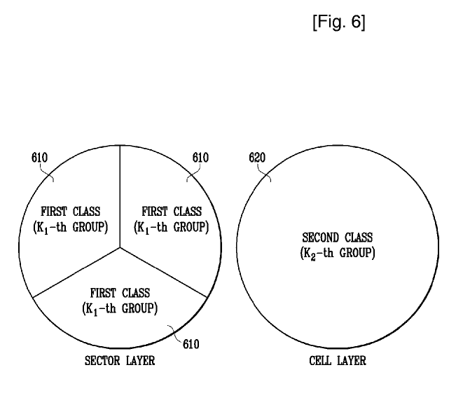

FIG. 6 is an illustration showing sector layers and a single cell layer of a single class in a layered cell structure according to an embodiment of the present invention, where a single frequency is divided into sector layers and a cell layer in a layered cell structure.

The sector layers constitute a cell using the sectors comprising the sane classes 610. The cell layer constitutes a cell with a single wireless area throughout the cell area comprising one class 620. This layered structure comprises 2 types of layers, and the carriers comprise 2 independent classes. The first class 610 is applied equally to the respective sectors in the sector layer, whereas the second class 620 is applied to the cell layer.

Namely, when the N groups are constructed into two classes, the one class is allocated to the sector layer to allocate wireless resources for the class that is the sane as the sector, and the other class is allocated to the cell layer.

When a collision occurs in the sector boundary in allocating the one class to the sector layer, the channel encoding technique and the forward error compensation method are used for data transmission. In allocating the other one class to the cell layer, the sane wireless resources are allocated to the overall area of the cell layer to constitute a layered cell structure. Here, the resources allocated to the sector layers and the cell layer are used differently according to a resource management method as follows.

(1) The users having a low movement speed are allocated to the sector layers that are relatively small in area, whereas the users having a high movement speed are allocated to the cell layer, thereby reducing the incidence of handover.

(2) The wireless resources of the cell layer are allocated to the users requiring a high-quality service in the sector boundary area.

(3) The wireless resources of the sector layers are allocated to a service having a low priority, whereas those of the cell layer are used for a service with a high priority.

(4) The sector layers allocate the resources of the cell layer to the users requiring a high data rate in the vicinity of the sector boundary to allow a selection of AMC (Adaptive Modulation Coding) that realizes high-speed data transmission.

Accordingly, the cell of a relatively small radius supports transmission of data having a large capacity and requesting high-speed transmission, low mobility, and real-time services sensitive to delay. Contrarily, the cell of a relatively large radius supports transmission of data having a small capacity, high mobility, and services insensitive to delay, and reduces overhead caused by a handover. By using this cell characteristic, services of a high quality can be provided to users in consideration of the mobility of the mobile station and the requested service quality.

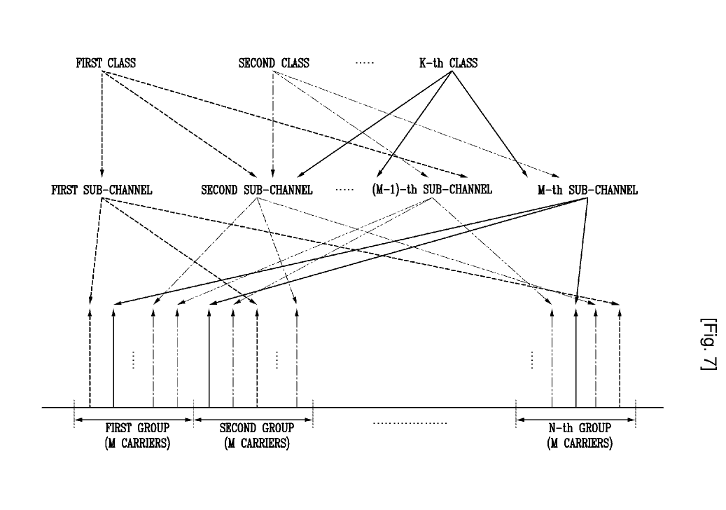

FIG. 7 is an illustration showing a class conception for sub-channel allocation according to an embodiment of the present invention, where the class conception is introduced as a conception for the carriers in addition to the group and sub-channel conception. All the carriers are divided into M sub-channels, and the sub-channels are divided into K classes.

In FIG. 7, each class comprises a plurality of carriers. Here, the classes are allocated to independent wireless areas that are represented by sectors and used for sector and cell allocation.

In the embodiment of the present invention, the class conception is introduced in addition to the existing sub-channel and group conceptions for allocation of a plurality of carriers so as to constitute a plurality of cells, allocating a plurality of carriers into cells or dividing the carriers into sectors to constitute a plurality of cells at the sane frequency. In the OFDMA, a plurality of carriers is allocated to constitute a plurality of layered cell structures comprising sector layers and a cell layer. In addition, the layer-specific wireless resources in the plural layered cell structures are used based on the service type, the user's mobility, and the modulation option.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The effects of the present invention are as follows: (1) the conception of independent classes is introduced for a plurality of carriers to facilitate the use of the carriers to a system requiring an independent wireless area, allowing design of sectors and cells at a single frequency; (2) in the method of dividing N groups into K classes, the groups are grouped by an arbitrary integer and allocated to K classes, distributing the groups allocated to the classes; (3) the independent classes comprising a plurality of groups are allocated to the sectors, eliminating an inter-sector interference and operating each sector as an independent wireless area; (4) the layered structure comprising sector layers and a cell layer provides diversity in the cell design and allows the use of resources according to the characteristic of users; (5) the wireless resource of the cell layer are allocated to the users having a high speed in the layered structure to reduce a handover in the sector interval, and decreasing an incidence of handover and the number of required control messages; and (6) the sector layers allocate the resources of the cell layer to the users requiring a high data rate in the vicinity of a sector boundary, allowing a selection of AMC for high-speed data transmission relative to the sector layers.

1. A method for constituting a layered cell, which is for constituting a cell in an OFDMA (Orthogonal Frequency Division Multiple Access) mobile communication system, the method comprising:
(a) dividing L carriers having orthogonality into M sub-channels;
(b) dividing the carriers into N groups each having the M sub-channels;
(c) grouping the N groups by an arbitrary integer into K classes; and
(d) constituting a plurality of layered cells corresponding to the K classes.

2. A method for constituting a layered cell, which is for constituting a cell in an OFDMA mobile communication system, the method comprising:
(a) dividing L carriers having orthogonality into M sub-channels;
(b) dividing the carriers into N groups each having the M sub-channels;
(c) grouping the N groups by an arbitrary integer into K classes; and
(d) constituting a plurality of layered cells corresponding to the K classes.

3. The method as claimed in claim 1, wherein in the step (c), the respective K classes include the same or a different number of groups.

4. The method as claimed in claim 3, wherein the step (c) comprises:
sequentially allocating the groups to each of the K classes, and allocating the (nK+k)-th group to the k-th class, when the respective K classes include the same number of groups.

5. The method as claimed in claim 3, wherein the step (c) comprises: arbitrarily allocating the respective N groups to each of the classes, when the respective K classes include a different number of groups.

6. The method as claimed in claim 1, wherein the plural layered cells of the step (d) includes sector layers comprising a plurality of sectors classified by wireless areas, and a cell layer comprising a single cell corresponding to an overall cell area.

7. The method as claimed in claim 6, wherein the step (d) comprises:
(d-1) allocating a capacity by sectors classified by wireless areas to map the classes to capacity;
(d-2) generating the classes by as many as the number of sectors; and
(d-3) allocating each class by sectors to constitute the sectors.

8. The method as claimed in claim 6, wherein the step (d) comprises:
(d-1) grouping the classes in a number of the sectors plus one;
(d-2) allocating each class to a sector area; and
(d-3) allocating the remaining class to a cell including the cell area.

9. The method as claimed in claim 6, wherein the step (d) comprises:
(d-1) grouping the N groups into two classes;
(d-2) allocating one class to the sector layers to allocate wireless resources for the classes equal in number to the sectors; and
(d-3) allocating the other class to the cell layer.

10. The method as claimed in claim 9, wherein the step (d-2) comprises: using a channel encoding technique and a forward error compensation method for data transmission when a collision occurs at a boundary of the sectors.

11. The method as claimed in claim 9, wherein the step (d-3) comprises:
allocating wireless resources equally throughout the area of the cell layer to constitute a layered cell structure.

12. The method as claimed in claim 6, wherein the sector layers allow a use of wireless resources for a user having a low movement speed, the cell layer allowing a use of wireless resources for a user having a high movement speed.

13. The method as claimed in claim 6, wherein the sector layers allow a use of wireless resources for a service having a low priority, the cell layer allowing a use of wireless resources for a service having a high priority.

14. The method as claimed in claim 6, wherein the sector layers allocate resources of the cell layer to a user requiring a high data rate in the vicinity of a sector boundary to allow a selection of AMC (Adaptive Modulation Coding) for high-speed data transmission.
